(19) United States
(12) Patent Application Publication
(10) Pub. No.: US 2025/0341231 A1
(43) Pub. Date: Nov. 6, 2025

(54) STEERING SYSTEM BEARING ASSEMBLIES WITH TUNABLE EXPANSION COMPENSATING BANDS

(71) Applicant: Steering Solutions IP Holding Corporation, Saginaw, MI (US)

(72) Inventors: Robert C. Derocher, Essexville, MI (US); Brad S. Sundholm, Bay City, MI (US); Jacob L. Kline, Saginaw, MI (US); Joseph Nigl, Saginaw, MI (US); Thomas Carter, Goodrich, MI (US)

(21) Appl. No.: 19/197,487

(22) Filed: May 2, 2025

Related U.S. Application Data
(60) Provisional application No. 63/642,008, filed on May 3, 2024.

(51) Int. Cl. F16C 27/02; B62D 3/02; B62D 5/04

(52) U.S. Cl. CPC F16C 27/02; B62D 3/02; B62D 5/0421; F16C 2326/01

(57) ABSTRACT

A steering system includes a steering gear assembly. The steering system also includes a bearing disposed on a rotating member within the output steering gear assembly. The steering system further includes an expansion compensating band disposed on an outer race of the bearing, wherein the expansion compensating band is tunable based on at least one parameter of the expansion compensating band to customize the radial stiffness and/or the torsional stiffness of the bearing.

### CROSS-REFERENCE TO RELATED APPLICATION

This application claims the benefits of priority to U.S. Provisional Patent Application Ser. No. 63/642,008, filed May 3, 2024, the disclosure of which is incorporated by reference herein in its entirety.

### FIELD OF THE INVENTION

The embodiments described herein relate to steering system bearing assemblies with tunable expansion compensating bands.

### BACKGROUND

A vehicle, such as a car, truck, sport utility vehicle, crossover, mini-van, marine craft, aircraft, all-terrain vehicle, recreational vehicle, or other suitable vehicles, include various steering system schemes, for example, steer-by-wire and driver interface steering. Steering systems include various rotating members which require bearings to constrain motion in a desired way and to control friction between the rotating member and a housing or other component. Expansion compensating bands may be used to reduce the effects of temperature changes on bearings that have a coefficient of thermal expansion different than the housings within which they are mounted in. For example, noise, vibration and lash are examples of undesirable effects which are addressed by expansion compensating bands. With the increasing number of electric vehicles coming to the automotive market, noise and rattle performance of components, such as gears, is becoming more important without the internal combustion engine background noise to mask or dampen acoustics.

Expansion compensating bands are placed on the outer race of bearings which interface to the housing bore in some systems. The bands help maintain the original bearing setting through temperature variations experienced by the bearing and housing. Therefore, the bands are solely designed for radial tolerance compensation.

### SUMMARY

According to one aspect of the disclosure, a steering system includes a steering gear assembly. The steering system also includes a bearing disposed on a rotating member within the output steering gear assembly. The steering system further includes an expansion compensating band disposed on an outer race of the bearing, wherein the expansion compensating band is tunable based on at least one parameter of the expansion compensating band to customize the radial stiffness and/or the torsional stiffness of the bearing.

According to another aspect of the disclosure, a bearing assembly includes a housing having an inner wall to define an interior. The bearing assembly also includes a bearing disposed within the interior and having an outer race. The bearing assembly further includes an expansion compensating band disposed around the outer race, wherein the expansion compensating band is tunable based on at least one parameter of the expansion compensating band to customize the radial stiffness and/or the torsional stiffness of the bearing.

According to another aspect of the disclosure, a method of customizing the radial stiffness and/or torsional stiffness of a bearing assembly is provided. The method includes selecting from a plurality of tunable parameters for an expansion compensating band, wherein the plurality of tunable parameters is at least one of a material, a thickness, a width, a geometry of a radially outer surface of the expansion compensating band which contacts a surrounding component, and a spacing between the expansion compensating band and an adjacent expansion compensating band. The method also includes securing the expansion compensating band to an outer race of a bearing.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 schematically illustrates a vehicle steering system;

FIG. 2 is a perspective view of a steering gear assembly in the vehicle steering system;

FIG. 3 is a cross-sectional view of the steering gear assembly having a bearing assembly disposed therein;

FIG. 4 is a perspective view of a bearing of the bearing assembly for use in the vehicle steering system with a plurality of expansion compensating bands;

FIG. 5 is an elevation, cross-sectional view of the bearing of FIG. 4;

FIG. 6 is an elevation, cross-sectional view of a radially outer portion of the bearing of FIG. 4 illustrating various tunable parameters for the expansion compensating bands;

FIG. 7 is an elevation, cross-sectional view of a radially outer portion of the bearing of FIG. 4 illustrating variable geometries of the expansion compensating bands;

FIG. 8 is an elevation, cross-sectional view of the bearing with a single expansion compensating band;

FIG. 9 is an elevation, cross-sectional view of a radially outer portion of the bearing of FIG. 8;

FIG. 10 is a plot of torsional stiffness for three embodiments of expansion compensating band configurations for the bearing; and

FIG. 11 is a plot of radial stiffness for three embodiments of expansion compensating band configurations for the bearing.

### DETAILED DESCRIPTION

The following discussion is directed to various embodiments of the disclosure. Although one or more of these embodiments may be described in more detail than others, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable vehicles, include various steering system schemes, for example, steer-by-wire and driver interface steering. These steering system schemes typically include a steering column for translating steering input to an output that interacts with a steering linkage to ultimately cause the vehicle wheels (or other elements) to turn the vehicle.

The embodiments disclosed herein relate to a bearing assembly having tunable expansion compensating bands. As disclosed herein, the number, characteristics and/or properties of the expansion compensating bands may be customized to provide a desired overall radial and torsional stiffness for the bearing relative to the components it is disposed between.

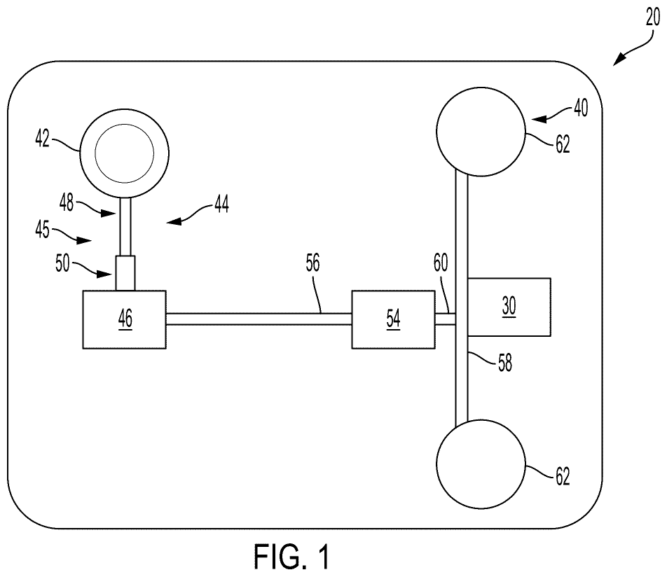

Referring initially to FIG. 1, a vehicle 20 is generally illustrated according to the principles of the present disclosure. The vehicle 20 may include any suitable vehicle, such as a car, a truck, a sport utility vehicle, a mini-van, a crossover, any other passenger vehicle, any suitable commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an ignition system, an electronic system, or combinations thereof.

The vehicle 20 includes a steering system 40. The steering system 40 may be configured as a driver interface steering system, an autonomous driving system, or a system that allows for both driver interface and autonomous steering. The steering system may include an input device 42, such as a steering wheel, wherein a driver may mechanically provide a steering input by turning the steering wheel. A steering column assembly 44 includes a steering column 45 that extends along an axis from the input device 42 to an output assembly 46. The output assembly 46 is part of a steer-by-wire and/or autonomous driving system. The output assembly 46 may be referred to as an emulator in steer-by-wire embodiments and is used to provide feedback to the steering input device 42 and to receive manual driver inputs for steering control. The steering column 45 includes two axially adjustable portions, for example, an upper jacket 48 and a lower jacket 50 that are axially adjustable with respect to one another.

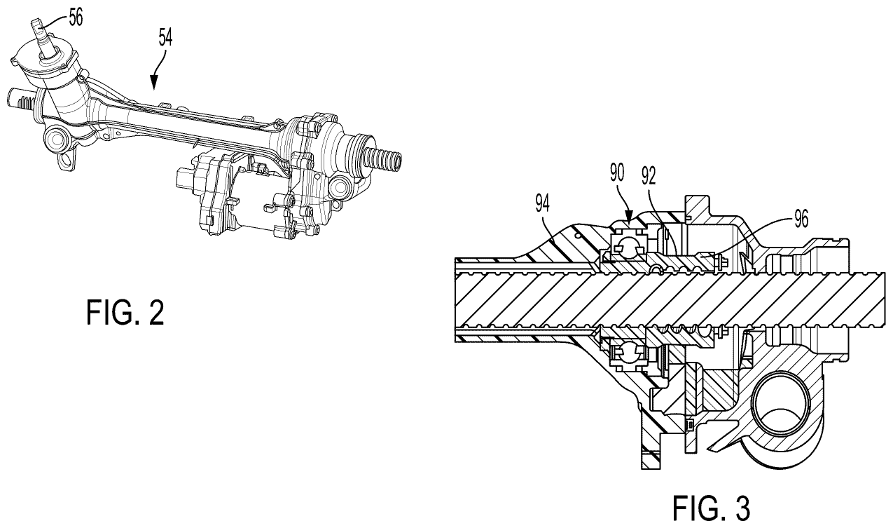

Referring to FIGS. 1 and 2, a steering gear assembly 54 may connect to the output assembly 46 via a steering gear input shaft 56. The steering gear assembly 54 may be configured as a rack-and-pinion, a recirculating ball-type steering gear, or any other types of steering gears associated with autonomous and driver-interface steering systems. The steering gear assembly 54 may then connect to a driving axle 58 via an output shaft 60. The output shaft 60 may include a pitman arm and sector gear and/or various traditional components. The output shaft 60 is operably connected to the steering gear assembly 54 such that a rotation of the steering gear input shaft 56 causes a responsive movement of the output shaft 60 and causes the drive axle to turn wheels 62. The illustrated embodiment of the steering gear assembly is merely an example of the gear assembly which may be used with the embodiments disclosed herein. For example, a steer-by-wire assembly without a pinion may benefit from the embodiments disclosed herein.

Regardless of the type of steering gear assembly being utilized, the system includes bearings to constrain motion in a desired way and to control friction between the rotating gear and a housing.

FIG. 3 illustrates a bearing assembly to be used in the steering gear assembly 54 is shown and is generally referenced with numeral 90. In the illustrated embodiment, the bearing assembly 90 is disposed between an inner wall 92 of a housing 94 of the steering gear assembly 54 and an outer surface of a ball nut 96.

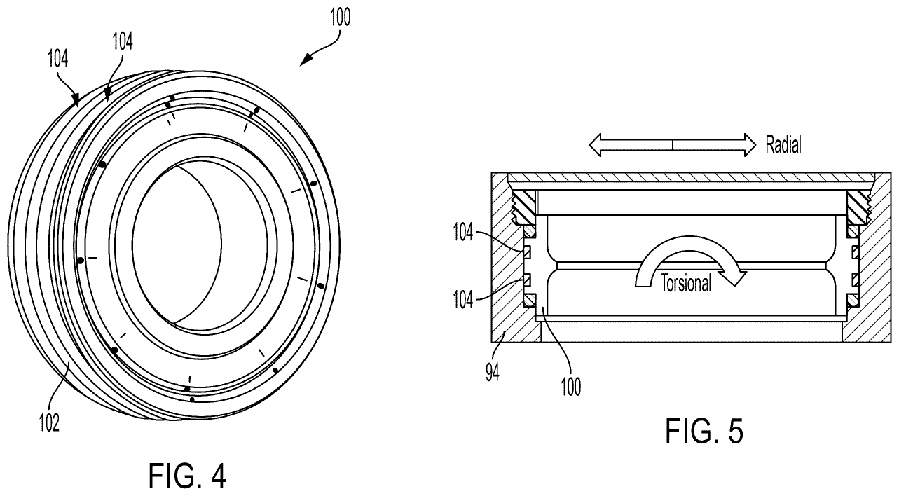

Referring now to FIGS. 4 and 5, regardless of the specific structure with which the bearing assembly 90 is utilized, the bearing assembly 90 includes a bearing 100 having an outer race 102 with a pair of expansion compensating bands 104 disposed on the outer race 102, or within recesses of the outer race 102. The expansion compensating bands 104 may extend completely circumferentially around the outer race 102 of the bearing 100 or may be segments extending partially around the outer race 102. As discussed herein, the expansion compensating bands 104 may be customized to tune the radial stiffness and the torsional stiffness of the bearing 100, relative to the bearing 100 and surrounding components, such as the housing 94 and the ball nut 96, for example.

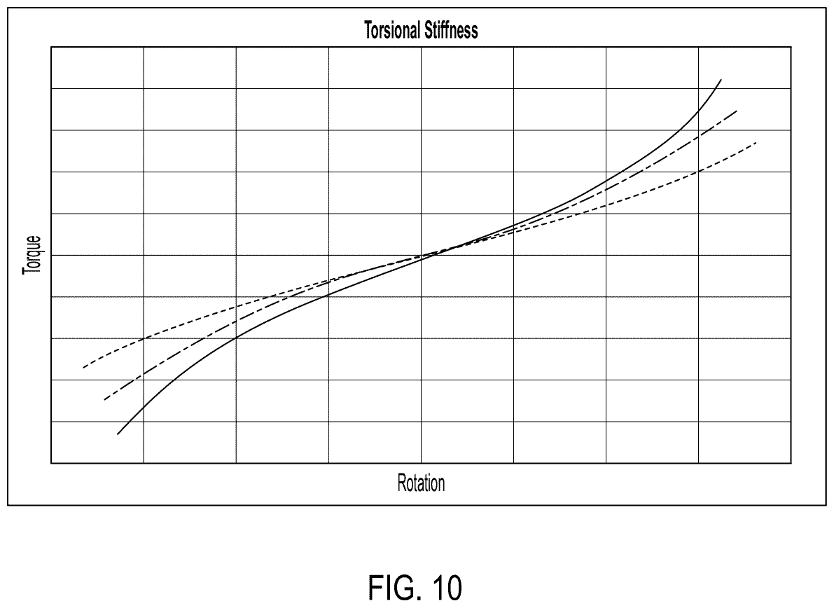

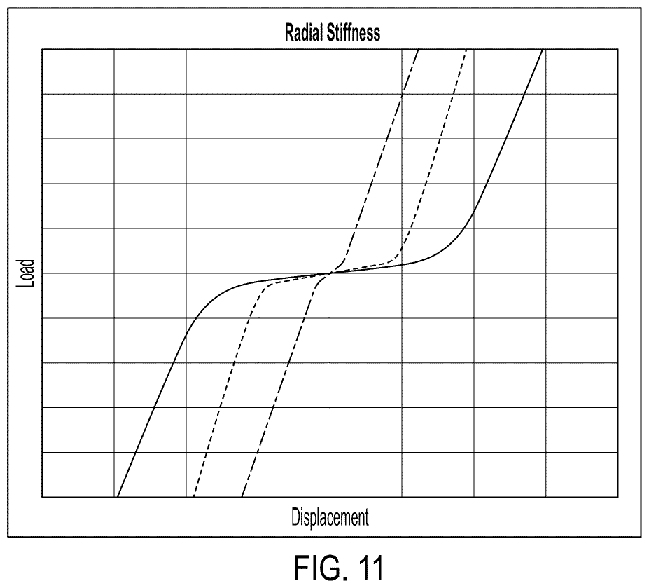

FIG. 5 is a cross-sectional view of the bearing 100 and includes directional indicators to orient the radial direction and the torsional direction. Movement and stiffness in the radial direction, as well as the torsional direction, may be customized with the expansion compensating bands 104. The ability to customize the radial and torsional stiffness of the bearing 100 has been unexpectedly found based on the embodiments disclosed herein, as represented by FIGS. 10 and 11. The expansion compensating bands 104 provide several tunable parameters, including but not limited to the material, width, thickness, spacing and interface geometry.

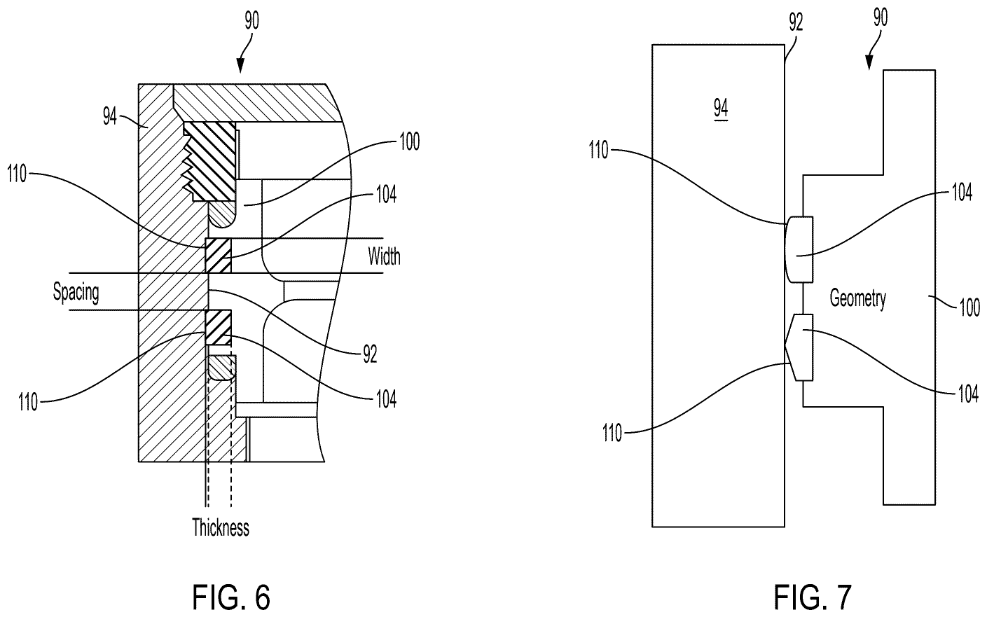

FIG. 6 illustrates the dimensional parameters which define the width and spacing of the expansion compensating bands 104, as well as the spacing between the expansion compensating bands 104. FIG. 7 illustrates different interface geometries of the expansion compensating bands 104. In particular, various shapes of a radially outer surface 110 of the expansion compensating bands 104 may be utilized as the surface which contacts the inner wall 92 of the housing 94, or any other intervening surface that the expansion compensating bands 104 may be in contact with. The texture of the radially outer surface 110 of the expansion compensating components 104 may be varied as an additional tunable parameter. It is also contemplated that different shapes or textures of the inner wall 92 of the housing 94—or any other surface which contacts the expansion compensating bands 104 may be varied to alter the interface geometry. The illustrated geometries of FIGS. 6 and 7 are merely examples of the geometries which may be utilized. In the illustrated examples, FIG. 6 shows a flat radially outer surface 110, while FIG. 7 shows a rounded radially outer surface 110 and an angled radially outer surface. These are non-limiting examples of the geometries of the radially outer surface 110.

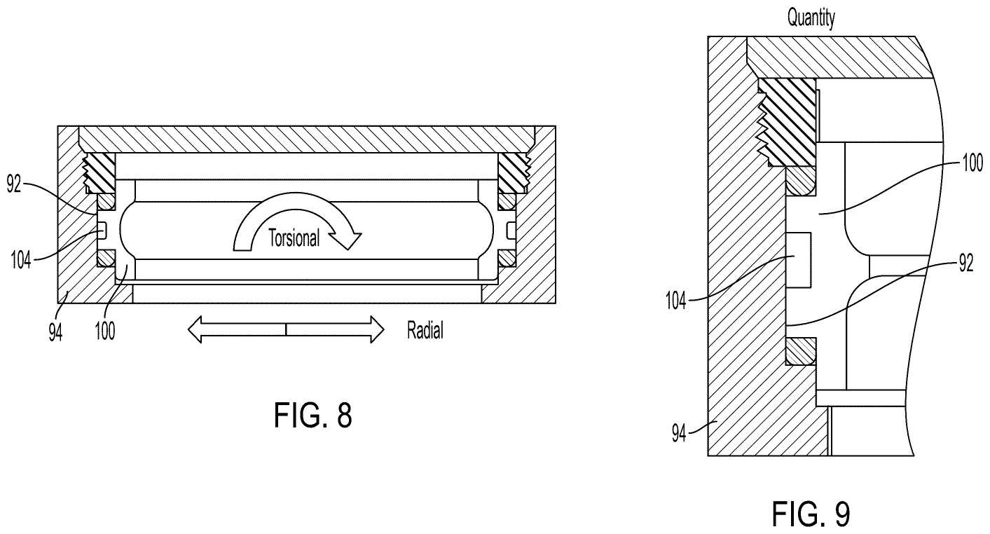

The embodiments of FIGS. 4-7 illustrate two expansion compensating bands 104, but the quantity of the expansion compensating bands 104 may also be modified to customize the radial and torsional stiffness. By way of example, FIGS. 8 and 9 illustrate an embodiment of the bearing 100 with a single expansion compensating band 104. However, it is to be appreciated that alternative numbers of bands 104 (i.e., more than two bands) may be provided on the outer race 102 of the bearing 100 in other embodiments. Regardless of the number of expansion compensating bands 104 utilized, it is to be appreciated that all of the other tunable parameters disclosed herein may be varies for any number of expansion compensating bands. Additionally, in embodiments with multiple expansion compensating bands, each band may have at least one tunable parameter which is different from at least one of the other expansion compensating bands.

FIGS. 10 and 11 depict radial and torsional performance of a single expansion compensating band, dual expansion compensating bands, and a modified dual expansion compensating band. The three plots in FIGS. 10 and 11 are merely examples of different expansion compensating band arrangements to illustrate the general principle that modification of the tunable parameters disclosed herein modifies the stiffness profiles for torsion and radial control. Rates for each of radial and torsional stiffness may be adjusted and are mutually exclusive of each other, such that one or both of the stiffness characteristics may be customized with the parameters disclosed herein.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. A steering system comprising:
a steering gear assembly;
a bearing disposed on a rotating member within the output steering gear assembly; and
an expansion compensating band disposed on an outer race of the bearing, wherein the expansion compensating band is tunable based on at least one parameter of the expansion compensating band to customize the radial stiffness and/or the torsional stiffness of the bearing.

2. The steering system of claim 1, wherein the at least one parameter is the material of the expansion compensating band.

3. The steering system of claim 1, wherein the at least one parameter is the thickness of the expansion compensating band.

4. The steering system of claim 1, wherein the at least one parameter is the width of the expansion compensating band.

5. The steering system of claim 1, wherein the at least one parameter is the geometry of a radially outer surface of the expansion compensating band which contacts a surrounding component.

6. The steering system of claim 5, wherein the surrounding component is an inner wall of a housing.

7. The steering system of claim 1, wherein the expansion compensating band is a first expansion compensating band, the steering system further comprising a second expansion compensating band.

8. The steering system of claim 7, wherein the at least one parameter is the spacing between the first expansion compensating band and the second expansion compensation band.

9. A bearing assembly comprising:
a housing having an inner wall to define an interior;
a bearing disposed within the interior and having an outer race;
an expansion compensating band disposed around the outer race, wherein the expansion compensating band is tunable based on at least one parameter of the expansion compensating band to customize the radial stiffness and/or the torsional stiffness of the bearing.

10. The bearing assembly of claim 9, wherein the at least one parameter is the material of the expansion compensating band.

11. The bearing assembly of claim 9, wherein the at least one parameter is the thickness of the expansion compensating band.

12. The bearing assembly of claim 9, wherein the at least one parameter is the width of the expansion compensating band.

13. The bearing assembly of claim 9, wherein the at least one parameter is the geometry of a radially outer surface of the expansion compensating band which contacts a surrounding component.

14. The bearing assembly of claim 13, wherein the surrounding component is an inner wall of a housing.

15. The bearing assembly of claim 9, wherein the expansion compensating band is a first expansion compensating band, the steering system further comprising a second expansion compensating band.

16. The bearing assembly of claim 15, wherein the at least one parameter is the spacing between the first expansion compensating band and the second expansion compensation band.

17. A method of customizing the radial stiffness and/or torsional stiffness of a bearing assembly comprising:
selecting from a plurality of tunable parameters for an expansion compensating band, wherein the plurality of tunable parameters is at least one of a material, a thickness, a width, a geometry of a radially outer surface of the expansion compensating band which contacts a surrounding component, and a spacing between the expansion compensating band and an adjacent expansion compensating band; and
securing the expansion compensating band to an outer race of a bearing.
